(19) United States
(12) Patent Application Publication
(10) Pub. No.: US 2024/0356699 A1
(43) Pub. Date: Oct. 24, 2024

(54) SIDELINK POSITIONING

(71) Applicant: ZTE Corporation, Shenzhen (CN)

(72) Inventors: Mengzhen LI, Shenzhen (CN); Chuangxin JIANG, Shenzhen (CN); Yu PAN, Shenzhen (CN); Qi YANG, Shenzhen (CN); Juan LIU, Shenzhen (CN); Junpeng LOU, Shenzhen (CN)

(21) Appl. No.: 18/758,965

(22) Filed: Jun. 28, 2024

Related U.S. Application Data
(63) Continuation of application No. PCT/CN2022/122947, filed on Sep. 29, 2022.

(51) Int. Cl. H04L 5/00; H04W 72/25; H04W 72/40

(52) U.S. Cl. CPC H04L 5/0048; H04W 72/25; H04W 72/40

(57) ABSTRACT

Systems, methods, and apparatus for wireless communication are described. A wireless communication method includes transmitting, by a wireless device, a sidelink positioning reference signal (SL-PRS) over a SL-PRS resource, where the SL-PRS resource is within a SL-PRS resource pool. The method further includes performing, by the wireless device, a sidelink positioning. The described techniques may be adopted by a network device or by a wireless device.

### CROSS REFERENCE TO RELATED APPLICATIONS

This patent document is a continuation of and claims benefit of priority to International Patent Application No. PCT/CN2022/122947, filed on Sep. 29, 2022. The entire content of the before-mentioned patent application is incorporated by reference as part of the disclosure of this application.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for performing sidelink positioning. Sidelink is the direct device-to-device communication.

A first example wireless communication method includes transmitting, by a wireless device, a sidelink positioning reference signal (SL-PRS) over a SL-PRS resource, where the SL-PRS resource is within a SL-PRS resource pool. The method further includes performing, by the wireless device, a sidelink positioning.

A second example wireless communication method includes receiving, by a network device, a sidelink (SL) related information request. The method further includes transmitting, by the network device, in response to the SL related information request, a SL related information report or a SL related information update.

A third example wireless communication method includes sensing, by a wireless device, a sidelink positioning reference signal (SL-PRS) configuration in a sensing window. The method further includes selecting, by the wireless device, based on the sensed SL-PRS configuration, a SL-PRS resource in a selection window.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary user equipment (UE) positioning.

FIGS. 2 and 3 illustrate exemplary sidelink (SL) data pool and SL positioning reference signal (SL-PRS) pool configurations.

FIG. 4 illustrates an exemplary resource pool hopping.

FIG. 5 illustrates an exemplary resource pool extension.

FIG. 6 illustrates an exemplary hybrid UE positioning.

FIGS. 7 and 8 illustrate exemplary SL configuration transfers between a gNodeB (gNB) and a location management function (LMF).

FIGS. 9 and 10 illustrate exemplary bit sizes of a SL-PRS sequence.

FIG. 11 illustrates an exemplary slot structure in a SL-PRS resource pool.

FIG. 12 illustrates an exemplary physical sidelink control channel (PSCCH) indicating/reserving SL-PRS resource(s).

FIGS. 13-17 illustrate exemplary SL-PRS time and frequency resource assignments indicated in control information.

FIGS. 18-22 illustrate exemplary SL-PRS sensing windows and selection windows.

FIG. 23 illustrates an exemplary comb offset pattern.

FIG. 24 is an exemplary flowchart for performing a SL positioning.

FIG. 25 is an exemplary flowchart for reception and transmission of SL related information.

FIG. 26 is an exemplary flowchart for sensing and selecting SL-PRS resources.

FIG. 27 illustrates an exemplary block diagram of a hardware platform that may be a part of a network device or a communication device.

FIG. 28 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

In the current technology, a UE can perform positioning with a NW via a uu interface by sending a SRS signal and receiving a PRS signal. However, the UE may also need to acquire its precise location even in some cases where the UE is out of the coverage of the NW, or the UE is in the coverage of the NW but has a rather low channel quality. Sidelink technology can suit the cases and be applied for V2X UEs to perform positioning. However, in the current spec sidelink technology only focuses on how to transmit control signaling and service data via PC5 interface. In this patent, methods and procedures of signaling transfer are provided to specify sidelink positioning, including SL-PRS resource pool design, sidelink configuration transfer between LMF and gNB, SL-PRS sequence generation, SPCI reserved SL-PRS, periodic SL-PRS and scheme 2 SL-PRS allocation/selection.

### Approved SI in RAN #94 for Rel-18 Positioning

Study and evaluate performance and feasibility of potential solutions for SL positioning, considering relative positioning, ranging and absolute positioning: [RAN1, RAN2]

Evaluate bandwidth requirement needed to meet the identified accuracy requirements [RAN1]

Study of positioning methods (e.g. TDOA, RTT, AOA/D, etc.) including combination of SL positioning measurements with other RAT dependent positioning measurements (e.g. Uu based measurements) [RAN1]

Study of sidelink reference signals for positioning purposes from physical layer perspective, including signal design, resource allocation, measurements, associated procedures, etc., reusing existing reference signals, procedures, etc. from sidelink communication and from positioning as much as possible [RAN1]

Study of positioning architecture and signaling procedures (e.g. configuration, measurement reporting, etc.) to enable sidelink positioning covering both UE based and network based positioning [RAN2, including coordination and alignment with RAN3 and SA2 as required]

Note: When the bandwidth requirements have been determined and the study of sidelink communication in unlicensed spectrum has progressed, it can be reviewed whether unlicensed spectrum can be considered in further work. Checkpoint at RAN #97 to see if sufficient information is available for this review.

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications, which include transmitting data to a BS (e.g., uplink transmissions) and receiving data from a BS (e.g., downlink transmissions). In SL communications, data is transmitted directly from a source UE to a target UE through, for example the Unified Air Interface (e.g., PC5 interface) without passing through a BS.

In current specification for sidelink communication, both resource allocation mode 1 and mode 2 are supported, where gNB schedules sidelink resources for UEs in Mode 1 and UEs autonomously select resources in Mode 2 (contention based scheme). A UE can be configured by higher layers with one or more sidelink resource pools. A sidelink resource pool can be for transmission of PSSCH, or for reception of PSSCH, and can be associated with either sidelink resource allocation mode 1 or sidelink resource allocation mode 2.

In frequency domain, a sidelink resource pool consists of (1 . . . 27) contiguous sub-channels. A subchannel consists of {n10, n12, n15, n20, n25, n50, n75, n100} contiguous PRBs. Both the number of subchannels per resource pool and subchannel size are higher layer parameters. In time domain, the set of slot that may belong to a sidelink resource pool excluding N_{SSB} slots (configured for S-SS/PSBCH block [S-SSB]) and N_{nonSL} slots (not semi-statically configured as UL) and reserved slots. After bitmapping, the set of slot (‘logic slot set’) are determined and assigned to a sidelink resource pool.

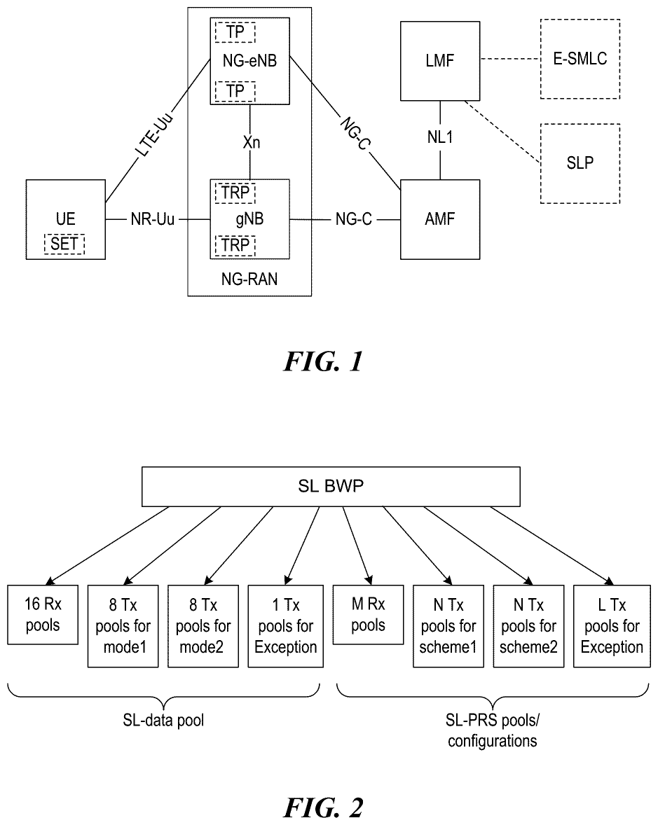

In Rel-15/16, in order to obtain the location information of a target UE, reference signals (downlink signals PRS/uplink signals SRS) transmitted between UEs and gNBs/ng-eNBs can be used to locate the target UE. FIG. 1 specified in TS 38.305 shows the architecture in 5GS applicable to positioning of a UE with NR or E-UTRA access.

The UE in this patent can be vehicle UE, or pedestrian UE, or RSU (road side unit) with or without known location, or PRU (positioning reference unit) with or without know location, or any UE that supports V2X service and/or sidelink communication.

Also, in this patent, the suffixes “-based” refers to the node that is responsible for making the positioning calculation (and which may also provide measurements).

Hybrid positioning (joint SL and Uu positioning) methods: where one or more of UE(s) perform sidelink measurements and position/ranging is estimated using measurements derived on both sidelink and Uu positioning; applied for in-coverage and/or partial-coverage scenarios.

Large bandwidth is required for high-accuracy positioning. If the SL-PRS is configured similarly as current sidelink RS within the frequency range of PSSCH, it is difficult to satisfy the positioning requirement. Therefore, we need to consider solutions/methods for large bandwidth SL-PRS configuration.

SL-PRS resource pool in this patent can be dedicated SL-PRS resource pool (detailed designs are shown in Embodiment 1), or shared resource pool (detailed designs are shown in Embodiment 2, Configure SL-PRS in sidelink communication pool).

Embodiment 3 can answer the question: who configure SL-PRS and who distribute/allocate SL-PRS resource.

Embodiment 4 mainly focus on SL-PRS sequence design, where several equations/formulas/solutions are provided for SL-PRS sequence initialization function.

Related to Embodiment 1, control information (e.g., SPCI) triggered/reserved SL-PRS (detailed designs are shown in Embodiment 5), and/or periodic SL-PRS (details are shown in embodiment 6) can be considered for dedicated SL-PRS resource pool.

Embodiment 5 contains the design for SPCI triggered/reserved SL-PRS, including slot structure, time/frequency resource for SPCI and the field content of SPCI.

Embodiment 6 focus on sensing window and selection window design for periodic SL-PRS.

Embodiment 7 considers how to select SL-PRS resource(s) based on sensing results.

### II. Embodiment 1

### Dedicated SL-PRS Resource Pool

Dedicated SL-PRS resource pool: SL-PRS can be (pre-)configured separately from SL communication pool. With regards to the multiplexing of the dedicated SL-PRS resource pool and SL communication resource pool, at least one of the following options can be selected:
Case 1. TDM between the dedicated SL-PRS resource pool and SL communication resource pool
Case 2. the time/frequency of resource pools are up to configuration

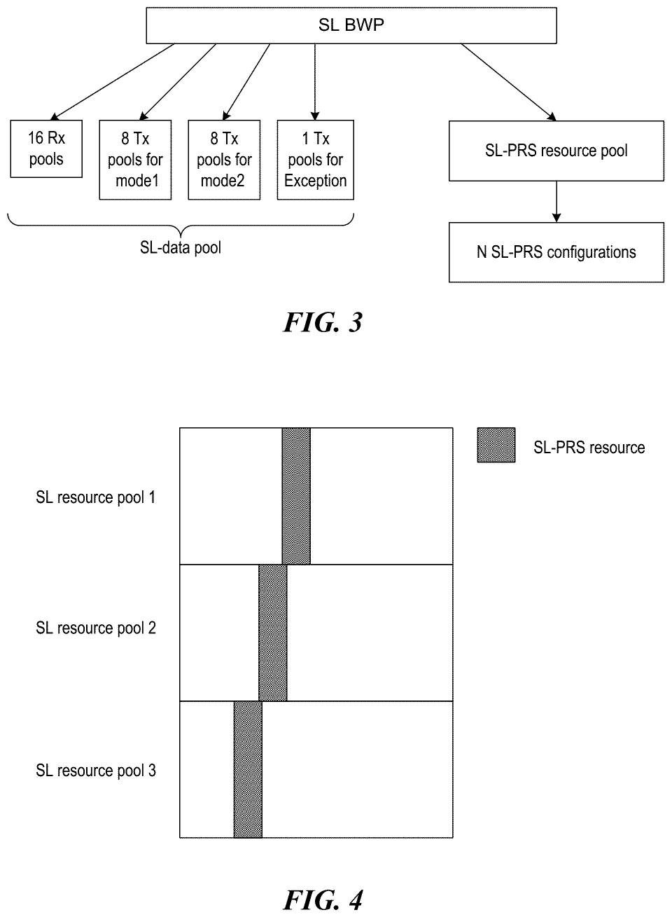

A UE can be (pre-)configured by high layers with one or more SL-PRS resource pools. As shown in FIG. 2, the SL-PRS and SL-data belong to the same BWP but different resource pool configuration. Each pool/configuration can occupy a part of the BWP resource including time and frequency resources. A sidelink resource pool can be for transmission of SL-PRS, or for reception of SL-PRS, and can be associated with either SL-PRS resource allocation scheme 1 or SL-PRS resource allocation scheme 2.

Scheme 1 SL-PRS resource pool: indicate the resources/configurations by which the UE is allowed to transmit SL-PRS based on network scheduling on the configured BWP.

Scheme 2 SL-PRS resource pool: indicates the resources/configurations by which the UE is allowed to transmit SL-PRS by UE autonomous resource selection on the configured BWP.

Alternatively, as shown in FIG. 3, a UE can be (pre-) configured by high layers with only one SL-PRS resource pool. Each SL-PRS resource pool consists of one or more SL-PRS configurations (e.g. time-frequency resource, power control CBR, PSCCH, IUC, comb pattern, number of symbols, repetition, periodicity, muting pattern, SL-PRS resource ID, SL-PRS sequence ID). Different SL-PRS configuration may be chosen by higher layer (UE's higher layer, or gNB via RRC/DCI, LMF via LPP signaling) based on different positioning services, or UE has its pre-configured/default SL-PRS configuration.

### Case 1

In order to support pool level TDM, the following time domain and frequency domain design should be used. For maximum resource utilization, different SL-PRS resource pools are not restricted to be TDM or FDM.

For time resources of dedicated SL-PRS resource pool:
“logic slot set” for SL-PRS, the set of slot that may belong to a SL-PRS resource pool excluding at least one of the following:
N_{S-SSB} slots (configured for S-SS/PSBCH block [S-SSB])
N_{nonSL} slots (not semi-statically configured as UL)
the set of slot N_{mapped} that are determined and assigned to a sidelink resource pool (after bitmapping “sl-TimeResource-r16 BIT STRING (SIZE (10 . . . 160))”).
“logic slot set” for SL-PRS may include SL communication pool's reserved slots N_{reserved} and/or slots N_{non-mapped} which excludes N_{S-SSB} slots, N_{nonSL} slots and reserved slots but not assigned to sidelink resource pool according to the bitmap (sl-TimeResource-r16).

A sidelink communication resource pool consists of a set of time and frequency resources. The “logic slot set”, reserved slots, bitmap for SL-data is configured per sidelink communication resource pool. In other words, each sidelink communication resource pool have N_{non-mapped} and N_{reserved} slots. A UE can be (pre-)configured by high layers with one or more SL-PRS resource pools, and multiple UEs can be involved in SL-related communication. To make sure pool level TDM, SL-PRS resource pool should not be overlapped with any SL communication resource pool.

Alt.1: It is up to gNB or LMF's configuration, and/or UE's high layer (pre-)configuration.

Alt.2: UEs may be firstly broadcast its resource pool information/configurations including SL communication pool's time resources. With the knowledge of other UE's SL resource allocation, it is possible to select one TDM SL-PRS resource pool.

For frequency resources of dedicated SL-PRS resource pool:
Share the same BWP, same carrier with SL communication resource pool
The granularity of SL-PRS frequency resource
Reuse sub-channel
sub-channel may not be needed: SL-PRS may occupy all the RBs available or any

number of RBs in one SL-PRS resource pool; (details are described in the last paragraphs of embodiment 1)
The frequency resources consist of a set of contiguous RBs
The following parameters may be configured per SL-PRS resource pool by gNB in RRC or by LMF via LPP signaling
Number of RB+start RB, or start RB+end RB, or indicate all RBs in a BWP, or all RBs in carrier frequency are occupied
Or number of subchannels per resource pool, subchannel size and start RB, optionally with RB number in the SL-PRS resource pool

### Case 2

If a dedicated resource pool for SL-PRS multiplexed in a TDM manner with the resource pool for sidelink communication is applied, the positioning latency may be high. The distribution principle of reserved slots N_{reserved} is discretely and evenly distributed in SFN/DFN cycles (10240 ms), the interval between two reserved slots might be quite large. Moreover, if SL-PRS resource pool is not overlapped with any SL communication resource pools to make sure pool level TDM, the available slots for SL-PRS are limited. Therefore, this type of SL-PRS resource pool design is more suitable for services that do not require high positioning latency or for UEs with low velocity.

From latency reduction and positioning accuracy perspective, dedicated SL-PRS resource pool up to high layer configuration (not restricted in a TDM manner with SL communication resource pool) may be designed:
For time resource configuration of a SL-PRS resource pool
may overlap with SL-data and share the same/similar time logic slot with SL-data
Indicates the priority threshold used to determine whether SL-PRS transmission/pool/configuration/symbol/slot/resource(s) is prioritized over uplink/SL-data transmission/pool/configuration/symbol/slot/resource(s)

The priority may be indicated by both/either high layer signaling (e.g. RRC, LPP) and/or low layer (e.g. DCI, SCI, SPCI (sidelink positioning control information), MAC CE) signaling.
For frequency resource configuration of a SL-PRS resource pool
Contiguous RBs
The granularity of SL-PRS frequency resource
Reuse sub-channel
sub-channel may not be needed: SL-PRS may occupy all the RBs available or any number of RBs in one SL-PRS resource pool; (details are described in the last paragraphs of embodiment 1)

With regards to SL-PRS resource pool associated with either SL-PRS resource allocation scheme 1 or SL-PRS resource allocation scheme 2, at least one of the following can be considered:
SL-PRS Scheme 1 resource pool and scheme 2 resource pool will not have resource conflicts. It is up to pre-configuration or gNB/LMF's configuration.

There may have time/frequency resource overlapping between SL-PRS resource pools associated with two schemes.

Solution 1: Make sure the priority of SL-PRS in scheme 1 is higher than the priority of SL-PRS in scheme 2. If so, once resource conflicts with UE in scheme 2 are detected/sensed by a UE in scheme 1, UE in scheme 2 excludes those/the conflicting SL-PRS resource(s) reserved/triggered by UE in scheme 1.

Priority per pool: used to determine whether NR SL-PRS transmission in scheme 1 is prioritized over transmission of SL-PRS in scheme 2.

SCI/SPCI indicate scheme 1 or scheme 2. If UE receives SL-PRS configurations from gNB via DCI/RRC/MAC CE or receive LPP signaling from LMF, SCI may include a scheme indicator. The scheme indicator may occupy only one bit, e.g., 0 for scheme 2 and 1 for scheme 1.

Solution 2: UE in SL-PRS resource allocation scheme 1 may also need to transmit SL-PRS after sensing. After sensing, UE send its sensing results to gNB and/or LMF, gNB and/or LMF may further determine SL-PRS resource.

SL-PRS resource pool can be configured by gNB and/or LMF. At least one of the following parameters may be configured within/per SL-PRS resource pool:
1. SL-PRS resource pool configuration: time resource, frequency resource, priority
2. SL-PRS configuration: UE information (ID of UEs in a positioning session, source ID destination ID), SL PRS resource set/SL PRS resource configuration, SL PRS resource set/SL PRS resource list, SL PRS resource set/SL PRS resource ID, the period of SL PRS resource/SL PRS resource set, number of symbols that a SL PRS occupied in a slot, start symbol of SL PRS in a slot, SL PRS resource frequency location and bandwidth, SCS, comb size, RE offset, muting pattern, SL-PRS QCL information, periodic/semi-persistent/aperiodic SL PRS, priority of SL PRS resource/SL PRS resource set, SL-PRS sequence ID, Cyclic Prefix length of the SL-PRS Resource, repetition time gaps between two repeated instances of SL-PRS, SL-PRS repetition factor, slot offset.
3. Control information for SL-PRS (e.g., PSCCH/SPCI) configuration: time resource for SPCI, frequency resource for SPCI
4. synchronization reference(s): Indicates the allowed synchronization reference(s) which is (are) allowed to use the configured SL-PRS resource pool.
5. Scheme/mode 2 configuration: CBR config and its association relationship with SL-PRS transmission parameter, maximum number of reserved SL-PRS resources that can be indicated by an SPCI, indicates if it is allowed to reserve a sidelink resource for an initial transmission of a TB by an SPCI associated with a different TB, SL-PRS resource reservation period, sensing window, selection window, SL-PRS RSRP threshold, SL-PRS RSRP threshold
6. Power control configuration: e.g., maximum SL-PRS transmission power, alpha value and P0 value for either sidelink pathloss based power control or downlink pathloss based power control.

Frequency domain configuration for both case 1 and case 2 (sub-channel related):

If the concept of subchannel is used, similar design as SCI frequency resource, FRIV, definition of SL CR, SL CBR, SL RSSI, transmission parameter can be applied to SL-PRS.

If not, the granularity SPCI frequency resource, FRIV, SL-PRS CR, SL-PRS CBR, SL-PRS RSSI, SL-PRS transmission parameter can be defined as one or more PRBs.

### III. Embodiment 2

Shared resource pool for SL-PRS

Alternatively, SL-PRS resources can be configured in SL communication resource pool (SL-ResourcePool), in other words, SL-PRS and SL-data transmission/reception share the same resource pools and same logic slot set. In order to achieve high-accuracy positioning, enlarged SL-PRS frequency resources are needed for SL positioning. at least one of the following solutions can be used:

### Case 1: Use “Remaining PRB” for SL-PR

According to the following table specified in TS 38.331, the granularity of SL resource pool's frequency resources is subchannel, each SL resource pool consists of “sl-NumSubchannel” contiguous sub-channels and one subchannel include “sl-SubchannelSize” contiguous PRBs. However, RRC parameter “sl-RB-Number” also indicates the number of PRBs in the corresponding resource pool, sl-NumSubchannel*sl-SubchannelSize are not always equal to sl-RB-Number. Therefore, there are some remaining PRBs which can be not used by PSCCH/PSSCH.

```
  sl-SubchannelSize-r16 ENUMERATED{n10, n12, n15, n20, n25, n50, n75, n100}
OPTIONAL,-- Need M
  sl-StartRB-Subchannel-r16 INTEGER (0..265) OPTIONAL, -- Need M
  sl-NumSubchannel-r16 INTEGER (1..27) OPTIONAL, -- Need M
  sl-RB-Number-r16 INTEGER (10..275) OPTIONAL, -- Need M
```

For SL-PRS configuration in frequency domain, the maximum PRB number of SL-PRS resource can be up to sl-RB-Number. Specifically, if remaining RBs are used by SL-PRS resource, SCI may indicate whether these PRBs are configured/used by SL-PRS and number of remaining PRBs in addition to start subchannel index and number of subchannels. The start of remaining PRBs is the end PRBs of the PSSCH resources in a resource pool.

### Case 2: Resource Pool Hopping

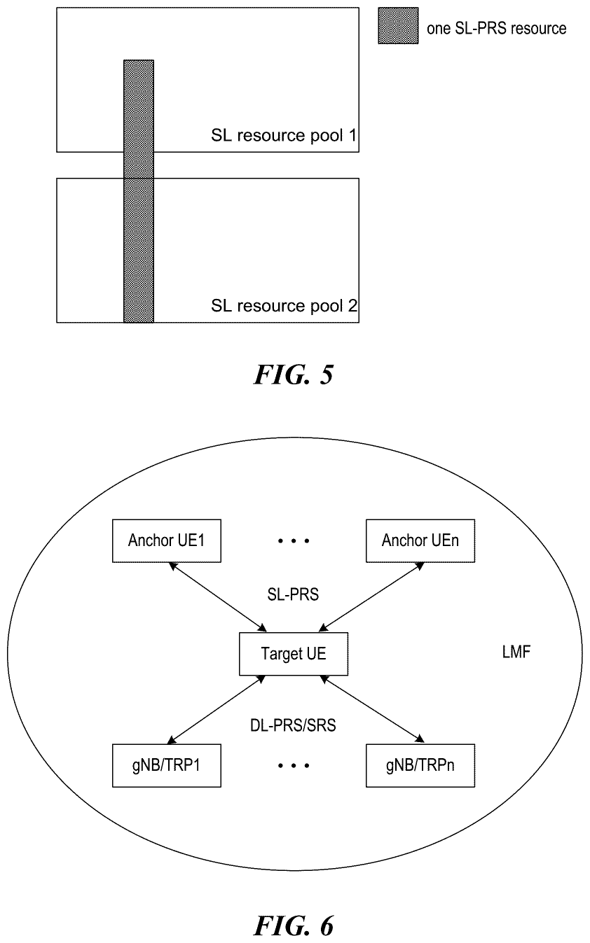

Not shared with one SL-data pool, but association/shared with several SL-data pools, as shown in FIG. 4. There are association relationships between SL-PRS resource pool and one or more SL-data resource pool(s).

SL-PRS resources transmitted in different SL resource pool may be partially overlapping depending on each resource pool's frequency range. Random phase rotation between two hops can be solved by the overlapping frequency resources.

Certain indication is needed, at least one of the following may be used:

One or more SL resource pool index indication: In scheme/mode 1, DCI/RRC/LPP signaling may indicate one or more SL resource pool index to UE. Time gap and time/frequency resource assignment are needed for each SL resource pool. In scheme/mode 2, the higher layer of UE is in charge.

SL resource pool group list indication: group list may be configured by gNB and/or LMF via DCI/RRC/LPP signaling, or be preconfigured. Both Tx UE and Rx UE should be informed about the SL resource pool group information. For example, Rx UE may aggregate several SL-PRS resources with the same group ID.

Within each resource pool group, gNB or LMF or UE may also report resource pool index within the group.

For SL-PRS resources in a group of SL resource pool, or (pre)configured one or more SL-PRS resource pools, at least one or more of the following parameters should be the same to ensure receiver side can combine the multiple SL-PRS resources from different SL resource pools:
SCS
Comb size
Comb offset
UE information (e.g., UE ID, source ID, destination ID)
SL-PRS sequence ID
SL-PRS resource bandwidth
CP type
SL-PRS periodicity and slot offset
SL-PRS resource repetition
SL-PRS resource time gap
number of symbols that a SL PRS occupied in a slot
start symbol of SL PRS in a slot
SL PRS resource frequency location and bandwidth
muting pattern
SL-PRS QCL information
Switching gap between SL-PRS resources in two SL-PRS resource pools may be needed.

SCI is needed for each SL resource pool (SCI 1 in SL resource pool 1, SCI 2 in SL resource pool 2, SCI 3 in SL resource pool 3).

From UE side, UE needs to report its capability to LMF or gNB for support of frequency/resource pool hopping. UE can also report its capability to LMF or gNB for support of overlapping between two frequency/resource pool hop.

At receiver side, UE can combine the linked SL-PRS resources from one or more pools or resource pool groups to get a combined measurement result. The UE combines the linked SL-PRS resources in frequency domain, the measurement based on the link SL-PRS resources from one or more pools or resource pool groups is equivalent to a larger bandwidth measurement.

At receiver side, UE needs to report the measurement results with SL resource pool group index or one or more SL resource pools index. If UE only reports one SL resource pool (group) ID, it implies the UE does not combine the measurement from multiple SL resource pools.

### Case 3: Extending SL-PRS Outside the SL Resource Pool in Terms of Frequency Domain

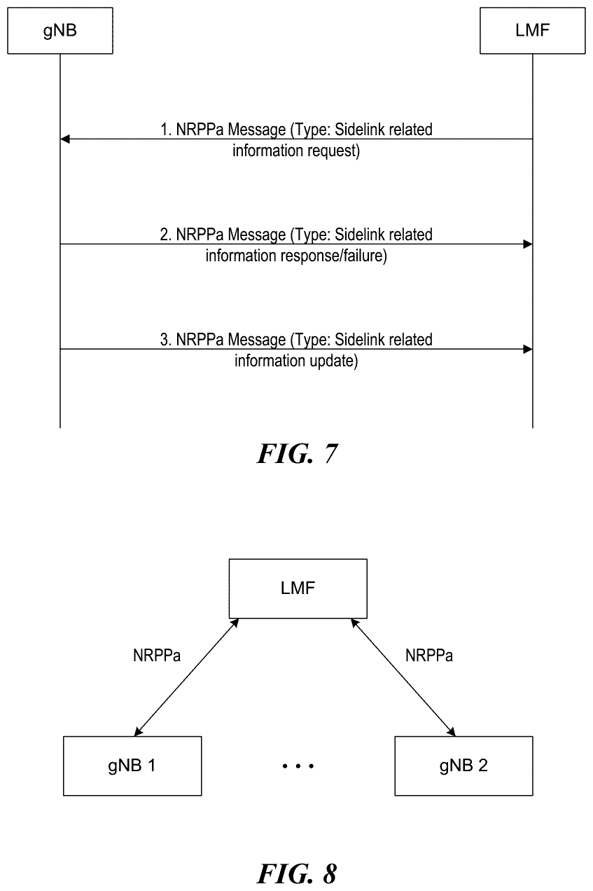

As shown in FIG. 5, the maximum PRB number for SL-PRS configuration in a SL communication resource pool can be larger than “sl-RB-Number”.

SCI format 1-A may need to indicate the frequency resource assignment of SL-PRS: the start of PRB index and the end PRB index/PRB number of the SL-PRS resources.

### Or the Start Subchannel Index and Number of Sub-Channels

Alternatively, 2^{nd}-stage SCI (existing 2ⁿd-stage SCI or new 2^{nd}-stage SCI format) can be used to trigger/reserve SL-PRS transmission resource.

### IV. Embodiment 3

### Sidelink Configuration Transfer Between LMF and gNB

In-coverage, out-of-coverage and partial-coverage scenarios should be considered for the study of sidelink positioning. Both network-based and UE-based positioning methods can be supported. Network can be involved in SL-PRS configuration or/and assistance data transmission or/and position calculation, etc. for sidelink positioning. For network-based positioning, UE may report necessary information to the network (including gNB and LMF, etc.) for the calculation. UE-based positioning refers to the solution where UE position is calculated by a UE.

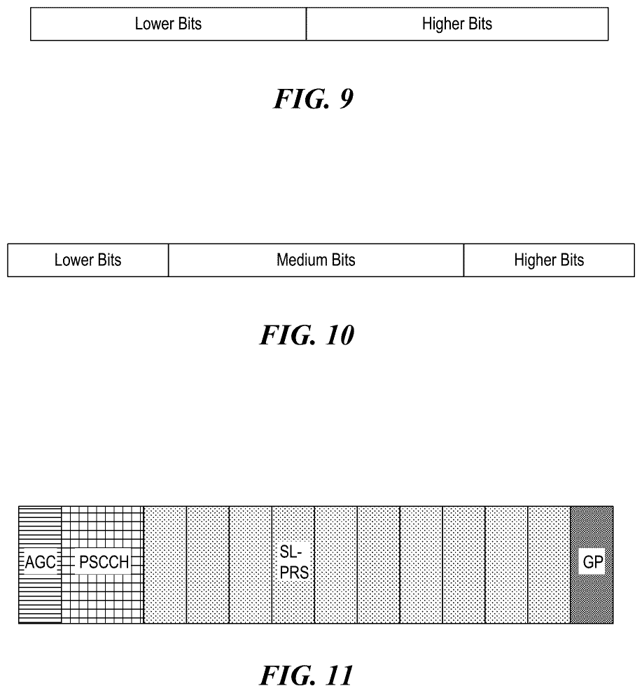

As shown in FIG. 6, according to 5G NR Uu positioning architecture, the LMF may interact with a target UE (through LPP) in order to deliver assistance data or to obtain a location estimate, and the LMF may also interact with the serving gNB or serving ng-eNB for a target UE in order to obtain position measurements for the UE, moreover, the LMF can determine the positioning methods based on UE positioning capabilities and gNB/ng-eNB information report and other factors.

For the design of NG-RAN UE SL positioning architecture, LMF should also be part of sidelink positioning to manage the support of different location services for target UEs. Especially when UEs in one positioning session have more than one serving NG-RAN nodes (e.g. gNBs), it is necessary to use LMF to interact with multiple NG-RAN nodes for assistance data information, the capability of NG-RAN nodes, location information. Moreover, hybrid positioning can be supported to further improve positioning accuracy by combining measurements derived on both SL and Uu positioning. The assistance data sent from LMF to UE may include both DL-PRS related information and SL-PRS related information. And LMF may collect both SL and Uu measurements to calculate UE's position.

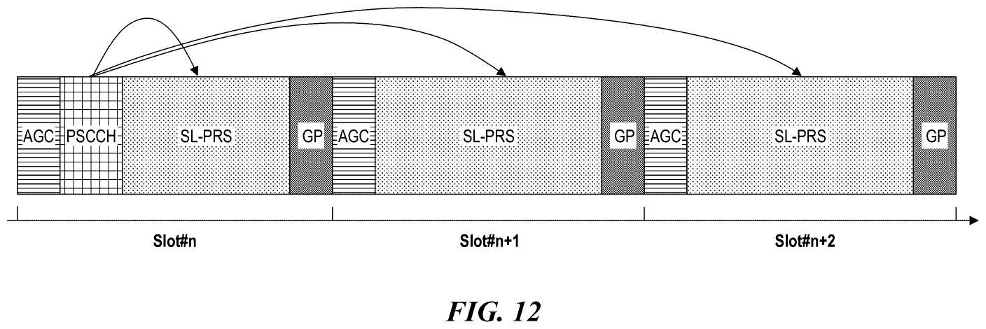

However, current sidelink communication do not need LMF's participation and clearly LMF does not have any sidelink related information. In order to support LMF's involvement for sidelink positioning and hybrid positioning, sidelink related information transfer between LMF and gNB should be supported, as shown in FIG. 7. Sidelink related information at least can be either conveyed in:
a new/separate NRPPa message
assistance data

The purpose of the procedures between LMF and gNB is to enable one or more gNB(s) to provide sidelink related information to the LMF, as shown in FIG. 8, for use in the calculation of positioning estimates at the LMF or enable the LMF to request sidelink communication or SL-PRS configuration information from the serving gNB of a target UE.

Specifically, LMF needs the information of time and frequency resources that can be used for sidelink transmission and/or reception (SL-data, SL-PRS). The requested sidelink related information sent from LMF to gNB may at least include one of the following:
TRP ID
UE SL-PRS configuration
Response time
Sidelink related information reporting type: triggered reporting, periodic reporting, condition based reporting (e.g. LMF requests gNB to report sidelink related configuration whenever the configuration changes)
UE identification information: LMF may inform gNBs about several UE's identification information involved in one positioning session.

The sidelink related information sent from gNB to LMF may at least include one of the following:
gNB information
PCI, GCI, ARFCN and TRP IDs of the TRPs served by the gNB
Timing information of TRPs served by the gNB
TRP type
Sidelink communication resources configuration configured by each gNB
UE information
Sidelink communication resource pool index for a UE
Tx resource pool
Rx resource pool
Mode 1 resource pool
Mode 2 resource pool
Exceptional resource pool
Time resource for each sidelink communication resource pool
“logic slot set” for one sidelink communication resource pool
Frequency resource for each sidelink communication resource pool
Location of frequency resource: Subchannel Size, Start RB, Number of Subchannel, RB number
SL-PRS resources configuration configured by each gNB
SL-PRS resource pool index for a UE
Tx resource pool
Rx resource pool
Scheme 1 resource pool: indicate the resources by which the UE is allowed to transmit SL-PRS based on network scheduling on the configured BWP.
Scheme 2 resource pool: indicates the resources by which the UE is allowed to transmit SL-PRS by UE autonomous resource selection on the configured BWP.
Exceptional resource pool
Time resource for each SL-PRS resource pool
“logic slot set” for one SL-PRS resource pool
Frequency resource for each SL-PRS resource pool
Location of frequency resource

At least one of the following options can be considered:

### Option1: LMF Sends SL-PRS Related Configurations to UE(s)

Alt. 1: Multiple gNBs (the serving gNB for a certain UE) involved in one positioning procedure/session send UEs' configured SL communication resource pool(s) information to LMF. It is up to LMF on how to configure SL-PRS resource pool/resource.

Alt.2: Multiple gNBs (the serving gNB for a certain UE) involved in one positioning procedure/session send UEs' configured SL-PRS resource pool(s) information to LMF. LMF can further inform SL-PRS resource pool/resource/configurations to UEs.

Alt.3: Multiple gNBs (the serving gNB for a certain UE) involved in one positioning procedure/session send UEs' configured SL-PRS resource information and SL communication resource pool related information to LMF. LMF can further inform SL-PRS resource pool/resource/configurations to UEs.

SL-PRS related configuration may be sent to UE(s) via LPP signaling, e.g. assistance data.

SCI or MAC CE, PC5 RRC may be used to indicate SL-PRS resource(s)/configurations/pool index/characteristics between UEs. or UE to UE only via SL-PRS sequence.

### Option2: gNB Sends SL-PRS Related Configurations to UE(s)

gNB may first transmit SL-PRS related configuration to LMF and ask for confirmation. LMF can decide whether SL-PRS is transmitted or not and to change the characteristics/configurations/pool/resource of SL-PRS transmission

### gNB Sends/Distributes/Allocates SL-PRS Pool/Resource/Configurations to UE

The signaling from gNB to UE can be either RRC or RRC and MAC CE (Uu), or RRC and DCI.

The signaling from UE to UE can be either SCI, or MAC CE, or only via SL-PRS sequence.

Multiple gNBs (the serving gNB for a certain UE) involved in one positioning procedure/session send UEs' configured SL-PRS resource pool(s) information to LMF. LMF can further use this information to calculate/estimate location.

UE can report its SL-PRS resource pool(s) information to LMF.

Moreover, timestamp which specifies the time instance where the measurement is performed or certain signal is received or transmitted is essential for positioning. The slot index we use in sidelink communication is based on the “logic slot set”, in order to access absolute timing (e.g., slot index is relative to slot #0 of the radio frame corresponding to SFN 0 of the serving cell or DFN 0) and support LMF-based SL positioning, at least one of the following can be considered:

For measurement report from UE to LMF, the timestamp and/or slot index is the absolute timing.

gNB or UE report UEs' configured SL-PRS resource pool(s) information to LMF. In such case, UE may only report the timestamp and/or slot index based on SL-PRS “logic slot set”.

### V. Embodiment 4

### Sequence Design

In order to meet the positioning accuracy requirements, reduce complexity and get better multiplexing between SL-PRS and other signals, gold sequence is preferable considering it is also used for both DL-PRS and reference signals (e.g., sidelink CSI-RS design) in SL communication. The sequence of SL-PRS r (m) can be generated according to

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence generator for DL-PRS and sidelink CSI-RS shall be initialized as follows (according to TS 38.211):

### DL-PRS

where the pseudo-random sequence c (i) shall be initialized with

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

where nu, is the slot number, the downlink PRS sequence ID n_{ID,seq}^{PRS} (0-4095) is given by the higher-layer parameter dl-PRS-SequenceID, and l is the OFDM symbol within the slot to which the sequence is mapped.

### CSI-RS for PSSCH

where the pseudo-random sequence c (i) is defined in clause 5.2.1. The pseudo-random sequence generator shall be initialised with

$${c}_{init} = ( {2}^{10} ( {N}_{symb}^{slot} {n}_{s , f}^{μ} + l + 1 ) ( 2 {n}_{ID} + 1 ) + {n}_{ID} ) mod {2}^{31}$$

at the start of each OFDM symbol where n_{s,f}^{μ} is the slot number within a radio frame, l is the OFDM symbol number within a slot, and n_{ID}=N_{ID}^{X} mod 210 where the quantity N_{ID}^{X} equals the decimal representation of CRC for the sidelink control information mapped to the PSCCH associated with the CSI-RS according to N_{ID}^{X}=Σᵢ₌₀^{L-1}pᵢ·2^{L-1-i} with p and L given by clause 7.3.2 in [4, TS 38.212].

For the design sequence generation for SL-PRS, initialization function design is one of the key factors for SL-PRS sequence. To be specific:

### Case 1: SL-PRS Sequence ID—Tx UE Information

SL-PRS sequence ID can be associated with UE information. For example, the sequence ID n_{ID} can be set as source ID, UE ID, or preconfigured sequence ID. The value of source ID (n_{s-ID}∈{0,1, . . . ,255}) carried in 2^{nd} stage SCI is indicated by higher layers.

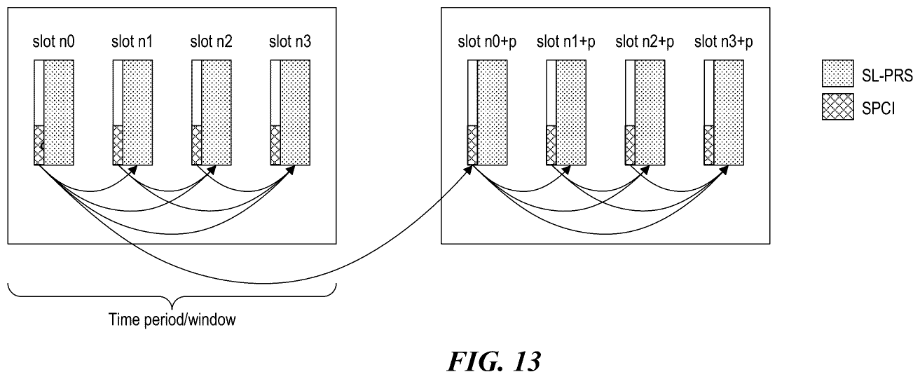

The pseudo-random sequence c (i) shall be initialized with

$${c}_{init} = ( {2}^{m} ( {N}_{symb}^{slot} {n}_{s , f}^{μ} + l + 1 ) ( 2 {n}_{ID} + 1 ) + {n}_{ID} ) mod {2}^{31}$$

where n_{s,f}^{μ} is the slot number within a radio frame, l is the OFDM symbol number within a slot, n_{ID} is SL-PRS sequence ID, m equals to the bit size of SL-PRS sequence ID. If n_{ID}=_{ns-ID}, the ‘Source ID’ as indicated by higher layers, m equals to 8. As shown in FIG. 9, there can be lower bits and higher bits.

### Case 2: SL-PRS Sequence—Rx UE Information

SL-PRS sequence can be associated with Rx UE information. The Tx UE and Rx UE information may include the following: Tx UE ID, Rx UE ID, source ID (8 bits), destination/target ID (16 bits), positioning service type, preconfigured sequence ID including both Tx UE information and Rx UE information. The destination ID configured by upper layer for NR sidelink communication transmission, which may include both Rx UE ID (especially for unicast) and sidelink service type (especially for broadcast and groupcast).

The pseudo-random sequence c (i) shall be initialized with

$${c}_{init} = ( {2}^{y} {n}_{Rx - iD} + {2}^{x} ( {N}_{symb}^{slot} {n}_{s , f}^{μ} + l + 1 ) ( 2 {n}_{Tx - ID} + 1 ) + {n}_{Tx - ID} ) mod {2}^{31}$$

where n_{s,f}^{μ} is the slot number within a radio frame, l is the OFDM symbol number within a slot, N_{Tx-ID} is SL-PRS sequence ID including Tx UE information, x equals to the bit size of n_{Tx-ID}, y is a constant, and it may either equal to (32-x) or other values.

If the bit size of n_{Rx-ID} is larger than x, an offset can be designed occupying higher bits. Initialization function of SL-PRS can be modified as:

$${c}_{init} = ( {2}^{y} ⌊ \frac{{n}_{Rx - ID}}{{2}^{x}} ⌋ + {2}^{x} ( {N}_{symb}^{slot} {n}_{s , f}^{μ} + l + 1 ) ( 2 {n}_{Tx - ID} + 1 ) + {n}_{Tx - ID} ) mod {2}^{31}$$

As shown in FIG. 10, there can be lower bits, medium bits, and higher bits.

### Case 3: Unique SL-PRS Sequence Identities

SL-PRS sequence ID can be associated with both Tx UE information and Rx UE information. There are 2^{m} unique SL-PRS sequence identities given by (where m=(x+z)):

$${n}_{ID}^{SL - PRS} = {n}_{Tx - ID} + {2}^{x} {n}_{Rx - ID}$$

Or given by:

$${n}_{ID}^{SL - PRS} = {n}_{Rx - ID} + {2}^{z} {n}_{Tx - ID}$$

Where the bit size of n_{Tx-ID} is x, the bit size of n_{Rx-ID} is z. The Tx UE and Rx UE information may include the following: Tx UE ID, Rx UE ID, source ID (8 bits), destination/target ID (16 bits), positioning service type, preconfigured sequence ID including both Tx UE information and Rx UE information.

The pseudo-random sequence c (i) shall be initialized with

$${c}_{init} = ( {2}^{m} ( {N}_{symb}^{slot} {n}_{s , f}^{μ} + l + 1 ) ( 2 {n}_{ID}^{SL - PRS} + 1 ) + {n}_{ID}^{SL - PRS} ) mod {2}^{31}$$

where n_{s,f}^{μ} is the slot number within a radio frame, l is the OFDM symbol number within a slot.

If the bit size of SL-PRS sequence m is too large, for example m is larger than m_max, an offset shall be added into the initialization function:

$${c}_{init} = ( {2}^{( 32 - m \_ max )} ⌊ \frac{{n}_{ID}^{SL - PRS}}{{2}^{s}} ⌋ + {2}^{m \_ max} ( {N}_{symb}^{slot} {n}_{s , f}^{μ} + l + 1 ) ( 2 ( {n}_{ID}^{SL - PRS} mod {2}^{m \_ max} ) + 1 ) + ( {n}_{ID}^{SL - PRS} mod {2}^{m \_ max} ) ) mod {2}^{31}$$

In order to align with DL-PRS's sequence design, s=1024, the pseudo-random sequence c (i) may be initialized with

$${c}_{init} = ( {2}^{22} ⌊ \frac{{n}_{ID}^{SL - PRS}}{1024} ⌋ + {2}^{10} ( {N}_{symb}^{slot} {n}_{s , f}^{μ} + l + 1 ) ( 2 ( {n}_{ID}^{SL - PRS} mod 1024 ) + 1 ) + ( {n}_{ID}^{SL - PRS} mod 1024 ) ) mod {2}^{31}$$

### Case 4: SL-PRS Configuration

SL-PRS sequence can be associated with some SL-PRS configuration information. This design is intended to enable period SL-PRS (pure higher-layer signaling without any lower layer signaling involvement). Once Rx UE receives the SL-PRS sequence, some SL-PRS confirmation information (e.g. priority) may be decoded.

The pseudo-random sequence c (i) shall be initialized with

$${c}_{init} = ( {2}^{n \_ c} {n}_{config} + {2}^{m} ( {N}_{symb}^{slot} {n}_{s , f}^{μ} + l + 1 ) ( 2 {n}_{ID} + 1 ) + {n}_{ID} ) mod {2}^{31}$$

where n_{s,f}^{μ} is the slot number within a radio frame, l is the OFDM symbol number within a slot, n_{ID} is SL-PRS sequence ID, n_{config} is associated with some SL-PRS configurations and occupy higher bits. n_c can equal to either (32-m) or (32-c), c is the bit size of n_{config}.

n_{config} may include at least one of the following SL-PRS configurations: priority of SL PRS resource/SL PRS resource set, the period of SL PRS resource/SL PRS resource set, number of symbols that a SL PRS occupied in a slot, comb size, muting pattern, SL-PRS QCL information, synchronization reference(s), power control configuration.

n_{config} may associated with more than one SL-PRS configurations, in such case, different SL-PRS configurations (to be included in SL-PRS sequence) occupy different bits. For example, priority may occupy the most high/significant bits among bit n_c to bit 32, and other configurations occupy less significant bits among bit n_c to bit 32.

One or more cases (case 1, case2, case3, case4) can be combined. For example, case 2 and case 4 can be combined to include both Rx UE information and SL-PRS configuration(s).

### VI. Embodiment 5

### SPCI Reserved SL-PRS

For describing simplicity, we use SPCI to imply the control information for SL positioning.

For dedicated SL-PRS resource pool, SPCI triggered/reserved SL-PRS, and/or periodic SL-PRS (details are shown in embodiment 5) can be considered.

When UE transmits SL-PRS, control information can be transmitted along with SL-PRS resource. Then other UEs can receive the aforementioned UE's control information. Based on the SL-PRS resource indicated/associated with the control information, other UEs can find whether and where to receive SL-PRS resources.

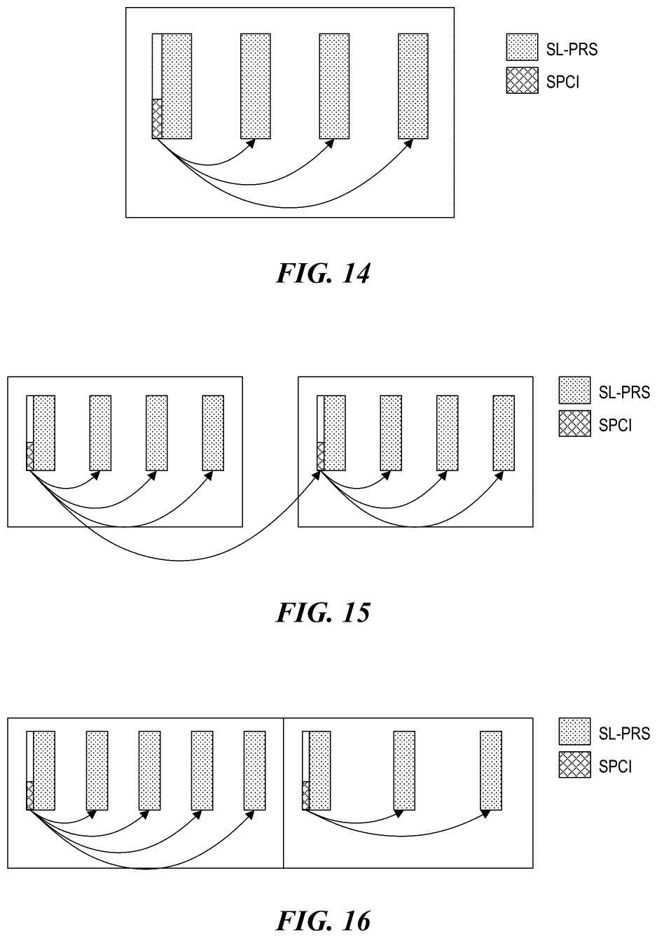

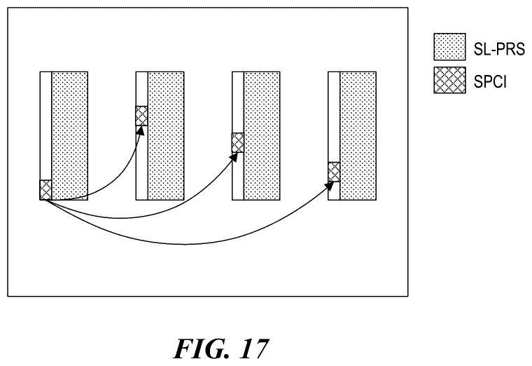

Slot structure of SL-PRS: each slot includes SPCI and SL-PRS (as shown in FIG. 11), or one SPCI triggers multiple SL-PRS occasions/samples (as shown in FIG. 12).

SPCI is carried in PSCCH.

Time resource for SPCI:
Number of symbols in a slot
consider at least one of the following: 1, 2, 3, . . . N symbol(s)
Period

Indicates the period of PSCCH resource in the unit of slots within this SL-PRS resource pool.

### Frequency Resource for SPCI:

### Number of PRBs:

Upper bound per resource pool: e.g. indicates the number of PRBs for PSCCH in a SL-PRS resource pool where it is not greater than the number of PRBs of the upper bound, the upper bound can be the number of PRBs of subchannel configured in the SL-PRS resource pool if subchannel configuration is supported.
Specific values: the number of PRBs for PSCCH in a SL-PRS resource pool
Frequency range: SL-PRS frequency domain resources can be divided into multiple parts/range, each part includes certain range of frequency resources. For one slot in a SL-PRS resource pool, one or more UE can only transmit SPCI in one configured frequency parts/range.

### Location:

RRC or LPP signaling may be used to indicate the start RB index and end RB index, or the start RB index and number of RBs. From a Rx UE perspective, it is beneficially for reducing SCI decoding/detection complexity.

For sidelink communication, SCI are carried in both PSCCH and PSSCH. SCI carried on PSCCH is 1^{st} stage SCI, which transports sidelink scheduling information. SCI carried in PSSCH is 2^{nd} stage SCI, which transports sidelink scheduling information, and/or inter-UE coordination related information.

However, for dedicated SL-PRS resource pool, two-stage SCI may not be needed anymore since SL-PRS will not transmitted in the same resource pool with SL-data which carried in PSSCH. Information carried in SPCI (Sidelink positioning control information) may include at least one of the following:
SL-PRS transmission/pool/configuration/symbol/slot/resource(s) Priority
SL-PRS resource allocation Scheme 1/scheme 2 indicator
SL-PRS Frequency resource assignment
SL-PRS Time resource assignment
The next/following SPCI time/frequency assignment
SL-PRS Resource Reservation period
SL-PRS pattern/configuration
SL-PRS periodicity
SL-PRS resource slot offset
SL-PRS resource symbol offset
SL-PRS Repetition
Symbol number of SL-PRS per slot
SL-PRS Muting pattern
SL-PRS resource power
SL-PRS Sequence ID
SL-PRS Comb size
SL-PRS Comb RE offset
UE information, e.g., Source ID
Destination ID
SL-PRS request/indication
Indicator for the presence or absence of one or more SL-PRS transmission
time restrict/valid time of one SPCI
Cast type
Zone ID
Communication range

To be specific, SL-PRS time/frequency resource assignment should at least consider the following cases:

### Case 1:

SPCI can be used for SL-PRS resource reservation. The fields “time resource assignment” and “frequency resource assignment” in SPCI are used to indicate the time-frequency resources of N SL-PRS transmissions within a time period/window. The last (N-1) SL-PRS resources are the repetition/retransmission of the first/initial SL-PRS resource for robust positioning. The length of time period/window and the value of N can be configured by gNB via RRC and/or DCI, MAC CE, or can be configured by LMF via LPP signaling.

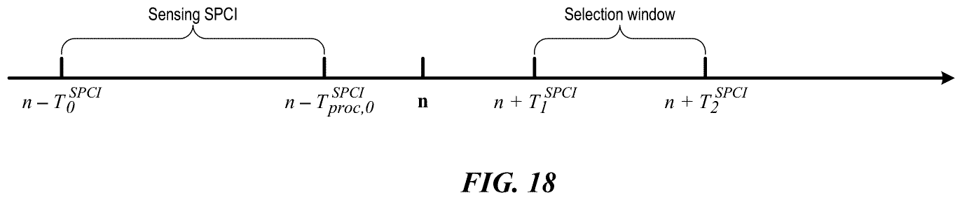

As shown in FIG. 13, the unit “SL-PRS resource reservation period” (p as shown in the following figure) can be either “ms” or slot, this field is used to indicate SL-PRS resources for the next cycle/periodicity. The value of SL-PRS resource reservation period can be configured by gNB via RRC and/or DCI, MAC CE, or can be configured by LMF via LPP signaling. The candidate value of SL-PRS resource reservation period (unit can be either ms or slot) may include at least one of the following: 1-99 (step: 1), 100, 160, 200, 300, 320, 400, 500, 600, 640, 700, 800, 900, 1000, 1280, 2560, 5120, 10240.

### Case 2:

As shown in FIG. 14, SPCI may indicate the time/frequency location of the first SL-PRS transmission, SL-PRS periodicity, the time restrict/valid time of one SCI, where the time restrict or valid time of one SCI may be configured by UE's higher layer, or configured by gNB via RRC and or DCI, or configured by LMF via LPP signaling. In other words, within the time restrict/valid time, SL-PRS resource will be transmitted based on the same periodicity, comb size, sequence ID and etc.

Moreover, as shown in FIG. 15, SPCI may indicate the time/frequency location of the next SPCI. Two adjacent/contiguous SPCI can indicate same or different SL-PRS resources which corresponding to same or different SL-PRS configurations.

### Case 3:

Similar as case 2, SPCI may indicate the time/frequency location of the first SL-PRS transmission, SL-PRS periodicity and other SL-PRS configurations. As shown in FIG. 16, UE may be configured/informed by UE's higher layer or LMF or gNB with several SPCI resources/location and each SPCI resource have one-to-one correspondence or associations with several SL-PRS configurations. Or, UE may be configured/informed by UE's higher layer or LMF or gNB with several SL-PRS resources/SL-PRS resource sets. Each SPCI may be used to reserve one or more SL-PRS resources with the same SL-PRS configurations or not. UE may only need another SPCI when SL-PRS resource/configuration is going to be changed under the condition of resource conflict based on sensing results, or high layer reconfiguration.

### Case 4:

As shown in FIG. 17, SPCI may also be used to indicate current SL-PRS transmission resource and the next/following SPCI resources. The time/frequency location within one slot of current SPCI and the following reserved SPCI may or may not be the same, however, even if they are different they may be corresponding to the same SL-PRS resource configuration for interference randomization.

Sensing window size for SPCI indicated SL-PRS:

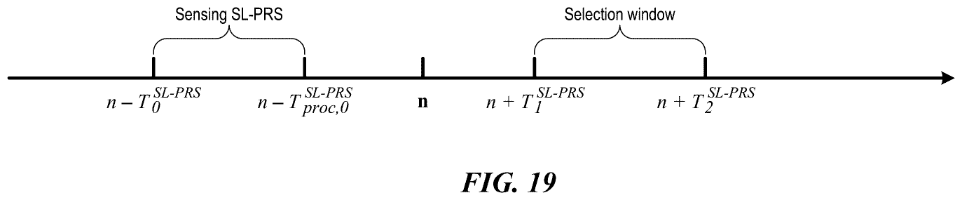

For case 2 and case 3, the sensing window size should be equal to or larger than the interval between adjacent/contiguous SPCI, as shown in FIG. 18.

### VII. Embodiment 6

### Periodic SL-PRS

For periodic SL-PRS transmission, in order to avoid resource collision, UEs need to firstly broadcast/unicast/multicast their sequence configuration (may including UE information) and SL-PRS configurations (e.g. SL-PRS resource/resource set ID, SL-PRS resource/resource set list, time domain send/transmission start location, periodicity, repetition, muting pattern, comb pattern, RE offset, priority, start PRB, slot offset, number of symbol per slot, SL-PRS resource power, SL-PRS QCL info, time gap between two repeated instance of SL-PRS corresponding to the same SL-PRS ID, SL-PRS subchannel size, number of subchannel etc.). Only when the UE obtains the sequence ID configuration information of other UEs, it can decode SL-PRS configuration correctly.

There are one-to-one correspondence or associations between SL-PRS sequence information and some SL-PRS configurations, which can be configured by LMF via LPP signaling or gNB (via RRC and/or DCI, MAC CE).

Scenario \textcircled{1}): Periodic SL-PRS resources are configured in dedicated resource pool, and SPCI reserved SL-PRS are not considered, as shown in FIG. 19.

The design of sensing window and selection window:

Sensing means sensing SL-PRS, decode its sequence ID and its associated SL-PRS configurations.

Sensing window size is related to SL-PRS periodicity and/or SL-PRS repetition time gap. Sensing window size consider all the periodicities configured for UEs in positioning session, the periodicity is a part of the broadcast message. If SL-PRS repetition is supported, the sensing window size may consider all the repetition time gaps between two repeated instances of SL-PRS corresponding to the same SL-PRS ID.

The length/end of periodic SL-PRS sensing window may also be related to priority.

Sensing window size is equal to or larger than the largest SL-PRS periodicities/repetition time gaps or the LCM (least common multiple) of multiple SL-PRS periodicities/repetition time gaps.

For any of the SL-PRS resources transmitted periodically, we have one sensing window to decide whether this particular one SL-PRS is available. Therefore, selection window may not be needed.

### Selection Window Includes Several SL-PRS Resources Configured for UE

The size of selection window can be n*T, T is SL-PRS periodicity or the time gap between two repeated instances of SL-PRS corresponding to the same SL-PRS ID

If UE finds/decodes multiple configured resources are not available or are conflict with other UE's SL-PRS resources within a time range/window, UE may need switch SL-PRS configuration.

Scenario \textcircled{2}: Scheme 2 resource allocation consider both periodic SL-PRS and SL-data

For the same SL-PRS selection window, the sensing window size of non-SCI SL-PRS may be different from the sensing window size of SL-data, as shown in FIG. 20.

### Sensing Window

Time domain:
max {SL-PRS sensing window size, SL-data sensing window size}
or, the union set of SL-PRS sensing window and SL-data sensing window

Frequency domain:
Consider the location of frequency resource for both SL-data pool and SL-PRS
Selection window in this scenario can be either the selection window for periodic SL-PRS as described in scenario \textcircled{1} or the selection window for SL-data.

Scenario \textcircled{3}: Scheme 2 resource allocation: if both periodic SL-PRS and SPCI reserved SL-PRS are supported, as shown in FIG. 21. Consider the conflicts which may happen among periodic SL-PRS and SPCI reserved SL-PRS.

### Sensing Window

Time domain:
max {periodic SL-PRS sensing window size, SPCI sensing window size}
or, the union set of periodic SL-PRS sensing window size, SPCI sensing window size
   Frequency domain:

Consider the location of frequency resource for SL-data pool, SPCI reserved SL-PRS and periodic SL-PRS

Selection window in this scenario can be either the selection window for periodic SL-PRS as described in scenario \textcircled{1} or the selection window for SPCI reserved SL-PRS as described in embodiment 6.

Scenario \textcircled{4}: Scheme 2 resource allocation: if both periodic SL-PRS and SPCI reserved SL-PRS are supported. Consider the conflicts which may happen among periodic SL-PRS, SPCI reserved SL-PRS and SL-data, as shown in FIG. 22.

### Sensing Window

Time domain:
max {periodic SL-PRS sensing window size, SPCI sensing window size, SL-data sensing window size}
or, the union set of periodic SL-PRS sensing window size, SPCI sensing window size and SL-data sensing window size

Frequency domain:
Consider the location of frequency resource for SL-data pool, SPCI reserved SL-PRS and periodic SL-PRS

Selection window in this scenario can be either the selection window for periodic SL-PRS as described in scenario \textcircled{1} or the selection window for SL-data or the selection window for SPCI reserved SL-PRS as described in embodiment 6.

If collision is detected by UE, how to choose?
SL-data, SCI SL-PRS have priority value indicated in SCI/SPCI
For periodic SL-PRS
Add priority related information to sequence.

Decode a set of SL-PRS configuration including priority information based on sequence ID configuration and/or resource transmission location information. When the UE obtains the sequence ID configuration information and/or resource transmission location information of other UEs, it can decode SL-PRS configuration including priority information.

Prioritization rules can be (pre)configured or specified, if so, at least one of the following rules can be applied:
periodic SL-PRS has higher priority than all other SL signals/data
periodic SL-PRS has lower priority than all other SL signals/data
periodic SL-PRS has higher priority than PSSCH, SCI/SPCI reserved SL-PRS but has lower priority than PSCCH.
periodic SL-PRS has higher priority than PSSCH, but has lower priority than SCI/SPCI reserved SL-PRS, PSCCH.
periodic SL-PRS has higher priority than PSCCH and SCI/SPCI reserved SL-PRS but has lower priority than PSSCH.
periodic SL-PRS has higher priority than PSCCH and PSSCH but has lower priority than SCI/SPCI reserved SL-PRS.
periodic SL-PRS has higher priority than PSCCH but has lower priority than PSCCH and SCI/SPCI reserved SL-PRS.
Based on whether SL-PRS sequence ID is odd or even, (pre)definition or (pre-)configuration is needed
odd sequence ID may be corresponding to higher priority or alternatively even sequence ID may be corresponding to higher priority.

### VIII. Embodiment 7

### Scheme 2 SL-PRS Resource Allocation

Different from SL communication, different SL-PRS resource from either different or same UE(s) may be multiplexing in a TDM manner or FDM manner.

For scheme2 UE autonomous selection of SL-PRS resources, whether the UE performs resource exclusion or not is not only related to the SL-PRS RSRP measurement and Tx priority (both UEs), but also to whether the sensing UE and the UE belonging to the SPCI being sensed are in the same positioning session and two UEs have positioning signaling interaction.

How to select SL-PRS resource based on sensing results?

For periodic SL-PRS

TDM: After sensing SL-PRS/decoding the sequence, if UE determines that the other UE(s) is its destination UE and/or source UE, or two UEs are in the same positioning session, then UE-A should exclude the SL-PRS resources reserved by other UEs.

FDM: After sensing SL-PRS/decoding the sequence, if UE determines that the other UE(s) is not its destination UE and/or source UE, or two UEs are not in the same positioning session, then there is no need for UE-A to exclude the resources reserved by other UEs. SL-PRS resources from two UEs can apply an FDM pattern.

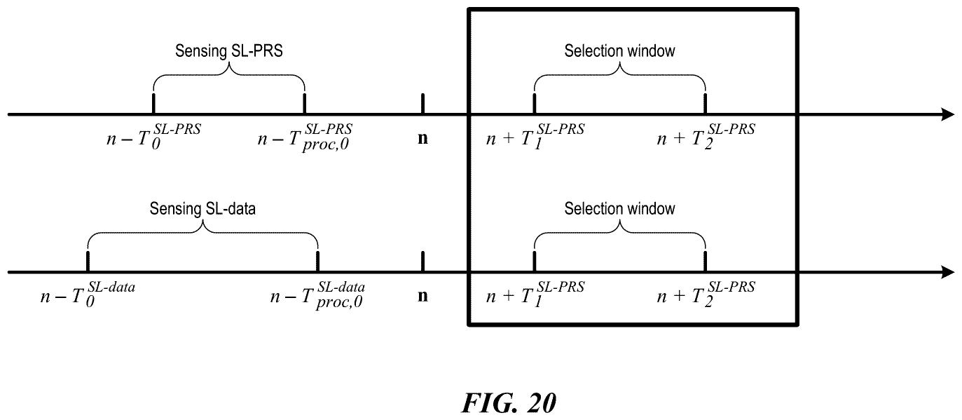

Two UEs may have different comb offset, as shown in FIG. 23, as long as two UEs have no positioning signaling interaction, UEs with different comb offset can transmit SL-PRS resources in the same slot/time.

### For SPCI Reserved SL-PRS

TDM: After sensing SPCI, if UE determines that the other UE(s) is its destination UE and/or source UE, or two UEs are in the same positioning session, then UE-A should exclude the SL-PRS resources reserved by other UEs.

FDM: After sensing SPCI, if UE determines that the other UE(s) is not its destination UE and/or source UE, or two UEs are not in the same positioning session, then there is no need for UE-A to exclude the resources reserved by other UEs. SL-PRS resources from two UEs can apply an FDM pattern.

Different UEs may have different comb offset.

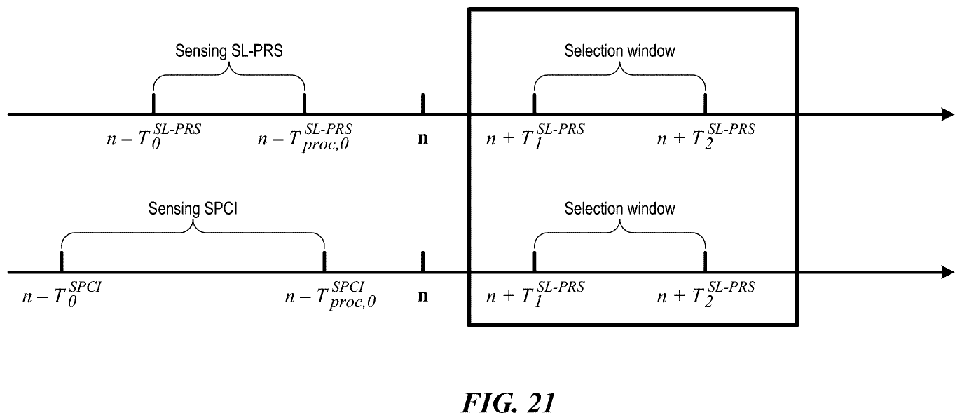

FIG. 24 is an exemplary flowchart for performing a sidelink (SL) positioning. Operation 2402 includes transmitting, by a wireless device, a sidelink positioning reference signal (SL-PRS) over a SL-PRS resource, where the SL-PRS resource is within a SL-PRS resource pool. Operation 2404 includes performing, by the wireless device, a sidelink positioning. In some embodiments, the method can be implemented according to Embodiments 1, 2, 4, and 5. In some embodiments, performing further steps of the method can be based on a better system performance than a legacy protocol.

In some embodiments, the method further includes performing, by the wireless device, a joint sidelink and uu positioning. In some embodiments, the SL-PRS resource pool can be configured by a gNodeB (gNB) or a location management function (LMF), or pre-configured and stored on the wireless device. In some embodiments, a configured SL-PRS resource pool has a higher priority than a pre-configured SL-PRS resource pool.

In some embodiments, the method further includes receiving, by the wireless device, a SL-PRS configuration, wherein one or more of the SL-PRS transmission, the SL-PRS resource, the SL-PRS resource pool, and the SL-PRS configuration are configured with a priority value.

In some embodiments, whether the SL-PRS resource pool is configured or pre-configured is indicated by a control information. In some embodiments, the SL-PRS resource pool is configured or pre-configured with one or more of a SL-PRS resource pool configuration, a SL-PRS configuration, a SL-PRS control information, a synchronization reference, a scheme 2 configuration, and a power control configuration.

In some embodiments, the SL-PRS resource pool occupies a resource pool different from one or more resource pools occupied by a SL-data communication. In some embodiments, the SL-PRS resource pool is configured or pre-configured with a logic slot set to avoid time domain overlapping with the SL-data communication.

In some embodiments, the SL-PRS resource pool shares a resource pool with a SL-data communication. In some embodiments, the SL-PRS resource pool is configured to use a reserved portion of a physical resource block (PRB) of the resource pool. In some embodiments, the SL-PRS resource pool is associated with another resource pool linked with the SL-data communication based on a SL resource pool index indication or a SL resource pool group list indication. In some embodiments, one or more of a SL-PRS sequence identification, a SL-PRS resource bandwidth, an identification of the wireless device, a comb size, and a comb offset are the same for the resource pool and the other resource pool.

In some embodiments, the SL-PRS resource pool is configured or pre-configured with a SL-PRS sequence derived based on a sequence generation equation or a sequence configuration. In some embodiments, the SL-PRS sequence is associated with an identification of the wireless device. In some embodiments, the SL-PRS sequence is associated with an identification of a receiving wireless device or a service type. In some embodiments, the SL-PRS sequence is associated with an offset value. In some embodiments, the SL-PRS sequence is associated with a SL-PRS configuration.

In some embodiments, the method further includes receiving, by the wireless device, a control information, where the control information is associated with the SL-PRS resource. In some embodiments, the control information and the SL-PRS resource are contained in a physical sidelink control channel (PSCCH). In some embodiments, the control information triggers one or more SL-PRS occasions or SL-PRS samples. In some embodiments, the control information includes a location and a priority of the SL-PRS resource. In some embodiments, the SL-PRS resource is divided into one or more frequency ranges, and the method further includes transmitting, by the wireless device, the control information over the one or more frequency ranges.

In some embodiments, the control information includes one or more of: a SL-PRS priority, a SL-PRS frequency resource assignment, a SL-PRS time resource assignment, a next control information time assignment, a next control information frequency assignment, a SL-PRS resource reservation period, a SL-PRS pattern, a SL-PRS configuration, a SL-PRS periodicity, a SL-PRS resource slot offset, a SL-PRS resource symbol offset, a SL-PRS repetition, a SL-PRS symbol number per slot, a SL-PRS muting pattern, a SL-PRS resource power, a SL-PRS sequence identification, a SL-PRS comb size, a SL-PRS comb offset, an identification of the wireless device, a SL-PRS request, a SL-PRS indication, an indicator for a presence of a SL-PRS transmission, an indication for an absence of a SL-PRS transmission, a time restriction of the control information, and a valid time of the control information.

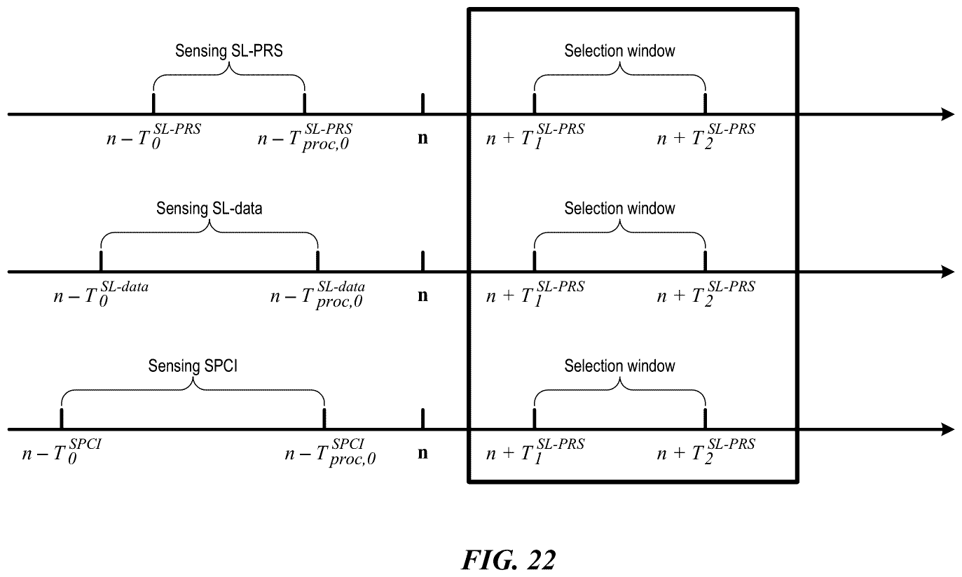

FIG. 25 is an exemplary flowchart for reception and transmission of sidelink (SL) related information. Operation 2502 includes receiving, by a network device, a sidelink (SL) related information request. Operation 2504 includes transmitting, by the network device, in response to the SL related information request, a SL related information report or a SL related information update. In some embodiments, the method can be implemented according to Embodiment 3. In some embodiments, performing further steps of the method can be based on a better system performance than a legacy protocol.

In some embodiments, receiving the SL related information request includes receiving the SL related information request from a location management function (LMF), and transmitting the SL related information report or the SL related information update includes transmitting the SL related information report or the SL related information update to the LMF. In some embodiments, the SL related information request includes one or more of an identification of a wireless device, an identification of a transmission/reception point (TRP), a SL positioning reference signal (SL-PRS) configuration, a SL related information reporting type, and a response time.

In some embodiments, the SL related information report or the SL related information update includes one or more of a gNodeB (gNB) information, a SL-data communication resource pool configuration including a logic slot set for the SL-data communication resource pool, and a SL positioning reference signal (SL-PRS) resource pool configuration including a logic slot set for the SL-PRS resource pool. In some embodiments, the method further includes transmitting, by the network device, a SL positioning reference signal (SL-PRS) related configuration to a wireless device.

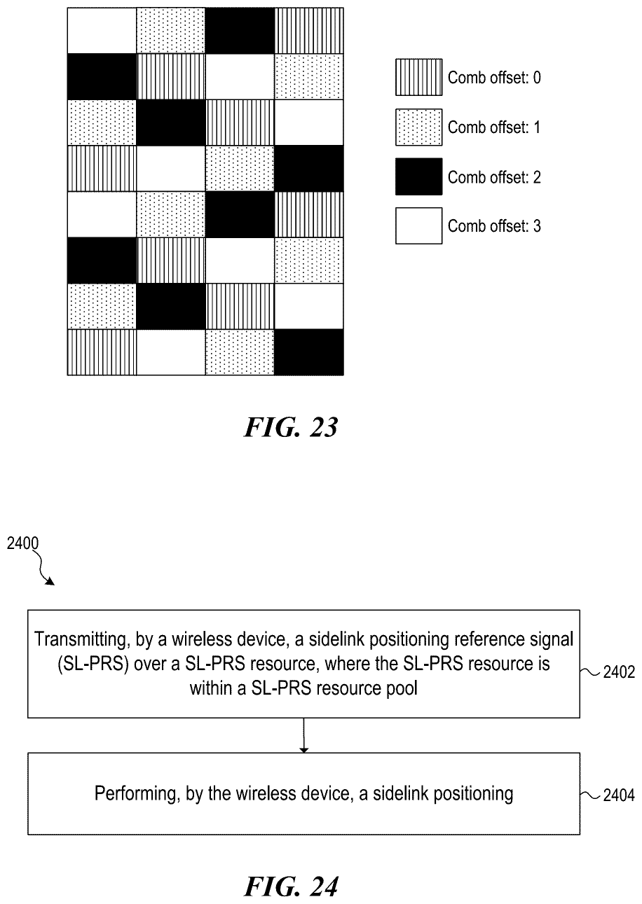

FIG. 26 is an exemplary flowchart for sensing and selecting SL-PRS resources. Operation 2602 includes sensing, by a wireless device, a sidelink positioning reference signal (SL-PRS) configuration in a sensing window. Operation 2604 includes selecting, by the wireless device, based on the sensed SL-PRS configuration, a SL-PRS resource in a selection window. In some embodiments, the method can be implemented according to Embodiments 5, 6, and 7. In some embodiments, performing further steps of the method can be based on a better system performance than a legacy protocol.

In some embodiments, the SL-PRS configuration includes a SL-PRS sequence, and sensing the SL-PRS configuration includes decoding the SL-PRS sequence. In some embodiments, the method further includes sensing, by the wireless device, a sidelink control information (SCI) for a SL-data communication. In some embodiments, a size of the sensing window is a maximum value or a union of a size of a sensing window for the SL-PRS configuration and a size of a sensing window for a SL-data communication.

In some embodiments, a size of the sensing window is related to a SL-PRS periodicity or a SL-PRS repetition time interval. In some embodiments, the selected SL-PRS resource is associated with a SL-PRS reference signal received power (RSRP) measurement, a SL-PRS priority, and a positioning session of the wireless device.

In some embodiments, the method further includes sensing, by the wireless device, a SL-PRS configuration indicated by a control information. In some embodiments, a size of the sensing window is equal to or greater than an interval between a control information and an adjacent control information. In some embodiments, selecting the SL-PRS resource includes avoiding a conflict between selecting a periodic SL-PRS configuration and a SL-PRS configuration indicated by a control information.

In some embodiments, a size of the sensing window is a maximum value or a union of a size of a sensing window for a periodic SL-PRS configuration and a size of a sensing window for a SL-PRS configuration indicated by a control information. In some embodiments, a size of the sensing window is a maximum value or a union of a size of a sensing window for a periodic SL-PRS configuration, a size of a sensing window for a SL-data communication, and a size of a sensing window for a SL-PRS configuration indicated by a control information.

In some embodiments, selecting the SL-PRS resource includes selecting a periodic SL-PRS configuration or the SL-PRS configuration indicated by the control information based on a priority value assigned to the periodic SL-PRS configuration and a SL-PRS configuration indicated by a control information. In some embodiments, selecting the SL-PRS resource includes selecting a periodic SL-PRS configuration or the SL-PRS configuration indicated by the control information based on a priority rule associated with the periodic SL-PRS configuration and a SL-PRS configuration indicated by a control information.

In some embodiments, the method further includes determining, by the wireless device, that another wireless device is in a same positioning session as or has a positioning signaling interaction with the wireless device. In some embodiments, the method further excluding, by the wireless device, the SL-PRS resource from being reserved or configured for use by the other wireless device.

In some embodiments, the method further includes determining, by the wireless device, that another wireless device is not in a same positioning session as or does not have a positioning signaling interaction with the wireless device. In some embodiments, the method further includes indicating, by the wireless device, that the SL-PRS resource is available to be applied with a frequency division multiplexing (FDM) to be reserved or configured for use by the other wireless device.

In some embodiments, the method further includes determining, by the wireless device, that another wireless device has a different comb offset from the wireless device. In some embodiments, the method further includes transmitting, by the wireless device, a SL-PRS over the SL-PRS resource in a same time domain resource with the other wireless devices.

A device that is configured or operable to perform the above-described methods are within the scope and the spirit of this patent document.

In some embodiments, the above-described methods are embodied in the form of processor-executable code and stored in a non-transitory computer-readable storage medium. The code included in the computer readable storage medium when executed by a processor, causes the processor to implement the methods described in this patent document.

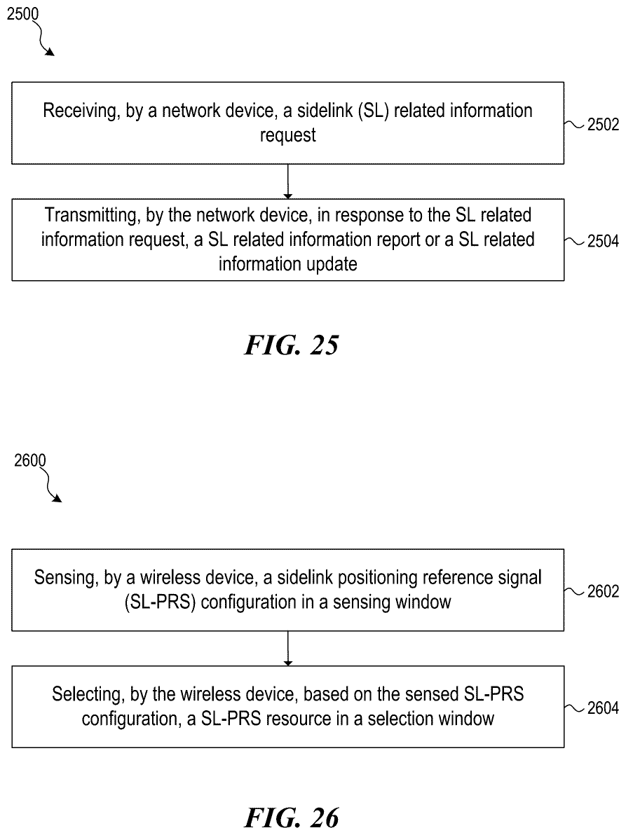

FIG. 27 shows an exemplary block diagram of a hardware platform 2700 that may be a part of a network device (e.g., base station) or a communication device (e.g., a user equipment (UE)). The hardware platform 2700 includes at least one processor 2710 and a memory 2705 having instructions stored thereupon. The instructions upon execution by the processor 2710 configure the hardware platform 2700 to perform the operations described in FIGS. 1 to 26 and in the various embodiments described in this patent document. The transmitter 2715 transmits or sends information or data to another device. For example, a network device transmitter can send a message to a user equipment. The receiver 2720 receives information or data transmitted or sent by another device. For example, a user equipment can receive a message from a network device. For example, a UE or a network device, as described in the present document, may be implemented using the hardware platform 2700.

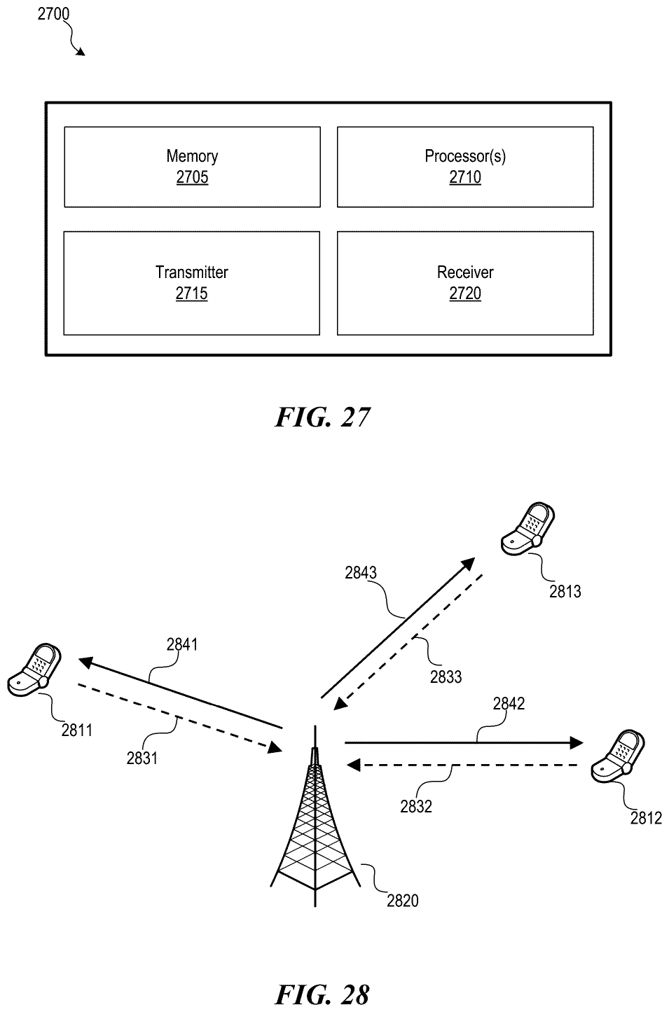

The implementations as discussed above will apply to a wireless communication. FIG. 28 shows an example of a wireless communication system (e.g., a 5G or NR cellular network) that includes a base station 2820 and one or more user equipment (UE) 2811, 2812 and 2813. In some embodiments, the UEs access the BS (e.g., the network) using a communication link to the network (sometimes called uplink direction, as depicted by dashed arrows 2831, 2832, 2833), which then enables subsequent communication (e.g., shown in the direction from the network to the UEs, sometimes called downlink direction, shown by arrows 2841, 2842, 2843) from the BS to the UEs. In some embodiments, the BS send information to the UEs (sometimes called downlink direction, as depicted by arrows 2841, 2842, 2843), which then enables subsequent communication (e.g., shown in the direction from the UEs to the BS, sometimes called uplink direction, shown by dashed arrows 2831, 2832, 2833) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 2820 depicted in FIG. 28. The UEs can also communicated with other UEs for sidelink communications.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
transmitting, by a wireless device, a sidelink positioning reference signal (SL-PRS) over a SL-PRS resource, wherein the SL-PRS resource is within a SL-PRS resource pool; and
performing, by the wireless device, a sidelink positioning.

2. The method of claim 1, wherein the SL-PRS resource pool is configured or pre-configured with at least one of a SL-PRS resource pool configuration, a SL-PRS configuration, a SL-PRS control information, a synchronization reference, a scheme 2 configuration, or a power control configuration.

3. The method of claim 1, wherein the SL-PRS resource pool occupies a resource pool different from one or more resource pools occupied by a SL-data communication.

4. The method of claim 1, wherein the SL-PRS resource pool shares a resource pool with a SL-data communication.

5. The method of claim 1, wherein the SL-PRS resource pool is associated with a resource pool linked with a SL-data communication based on a SL resource pool index indication or a SL resource pool group list indication.

6. The method of claim 1, wherein the SL-PRS resource pool is configured or pre-configured with a SL-PRS sequence derived based on a sequence generation equation or a sequence configuration.

7. The method of claim 1, further comprising receiving, by the wireless device, a control information, wherein the control information is associated with the SL-PRS resource, and wherein the control information comprises at least one of the following: a SL-PRS priority, a SL-PRS frequency resource assignment, a SL-PRS time resource assignment, a next control information time assignment, a next control information frequency assignment, a SL-PRS resource reservation period, a SL-PRS pattern, a SL-PRS configuration, a SL-PRS periodicity, a SL-PRS resource slot offset, a SL-PRS resource symbol offset, a SL-PRS repetition, a SL-PRS symbol number per slot, a SL-PRS muting pattern, a SL-PRS resource power, a SL-PRS sequence identification, a SL-PRS comb size, a SL-PRS comb offset, an identification of the wireless device, a SL-PRS request, a SL-PRS indication, an indicator for a presence of a SL-PRS transmission, an indication for an absence of a SL-PRS transmission, a time restriction of the control information, or a valid time of the control information.

8. A method of wireless communication, comprising:
transmitting, by a wireless device, a sidelink (SL) related information request; and
receiving, by the wireless device and in response to the SL related information request, a SL related information report or a SL related information update.

9. The method of claim 8, wherein the SL related information request comprises at least one of an identification of the wireless device, an identification of a transmission/reception point (TRP), a SL positioning reference signal (SL-PRS) configuration, a SL related information reporting type, or a response time.

10. The method of claim 8, wherein the SL related information report or the SL related information update comprises at least one of a gNodeB (gNB) information, a SL-data communication resource pool configuration comprising a logic slot set for the SL-data communication resource pool, or a SL positioning reference signal (SL-PRS) resource pool configuration comprising a logic slot set for the SL-PRS resource pool.

11. A method of wireless communication, comprising:
sensing, by a wireless device, a sidelink positioning reference signal (SL-PRS) configuration in a sensing window; and
selecting, by the wireless device, based on the sensed SL-PRS configuration, a SL-PRS resource in a selection window.

12. The method of claim 11, wherein a size of the sensing window is a maximum value or a union of:
a size of a sensing window for the SL-PRS configuration; and
a size of a sensing window for a SL-data communication.

13. The method of claim 11, wherein a size of the sensing window is related to a SL-PRS periodicity or a SL-PRS repetition time interval.

14. The method of claim 11, wherein a size of the sensing window is equal to or greater than an interval between a control information and an adjacent control information.

15. The method of claim 11, wherein selecting the SL-PRS resource comprises avoiding a conflict between selecting:
a periodic SL-PRS configuration; and
a SL-PRS configuration indicated by a control information.

16. The method of claim 11, wherein selecting the SL-PRS resource comprises selecting:
a periodic SL-PRS configuration or a SL-PRS configuration indicated by a control information based on a priority value assigned to the periodic SL-PRS configuration; and
a SL-PRS configuration indicated by a control information.

17. The method of claim 11, wherein selecting the SL-PRS resource comprises selecting:
a periodic SL-PRS configuration or a SL-PRS configuration indicated by a control information based on a priority rule associated with the periodic SL-PRS configuration; and
a SL-PRS configuration indicated by a control information.

18. The method of claim 11, further comprising:
determining, by the wireless device, that another wireless device is in a same positioning session as or has a positioning signaling interaction with the wireless device; and
excluding, by the wireless device, the SL-PRS resource from being reserved or configured for use by the other wireless device.

19. The method of claim 11, further comprising:
determining, by the wireless device, that another wireless device is not in a same positioning session as or does not have a positioning signaling interaction with the wireless device; and
indicating, by the wireless device, that the SL-PRS resource is available to be applied with a frequency division multiplexing (FDM) to be reserved or configured for use by the other wireless device.

20. The method of claim 11, further comprising:
determining, by the wireless device, that another wireless device has a different comb offset from the wireless device; and
transmitting, by the wireless device, a SL-PRS over the SL-PRS resource in a same time domain resource with the other wireless devices.
